(19) United States
(12) Patent Application Publication
(10) Pub. No.: US 2007/0055870 A1
(43) Pub. Date: Mar. 8, 2007

(54) Process for secure communication over a wireless network, related network and computer program product

(76) Inventors: Alessandro Bruti, Torino (IT); Gerardo Lamastra, Torino (IT); Alessandro Bruti, Torino (IT); Gerardo Lamastra, Torino (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/555,891

(22) PCT Filed: May 13, 2003
(86) PCT No.: PCT/IT03/00284

§ 371 Date: Nov. 7, 2005

(51) Int. Cl. H04L 9/00

(52) U.S. Cl. 713/168; 713/171

(57) ABSTRACT

In order to ensure secure communication over a wireless network, such as a network according to the 802.11 standard, the terminals in the network exchange information ciphered by means of at least one key. The key is generated independently at each terminal by means of the group key agreement type.

### FIELD OF THE INVENTION

This invention relates to wireless systems such as wireless local area networks (WLANs), and has been developed by paying specific attention to the possible use in connection with 802.11 Wireless Networks.

These networks are fully described and documented in the so-called 802.11b standard (802.11 Specs LAN/MAN Standard Committee of the IEEE Computer Society, Wireless LAN Medium Access Control (MAC) and Physical Layer (PHY), IEEE Standard 802.11) published in 1999.

However, reference to this specific possible application is in no way to be construed as limiting the scope of the invention

### DESCRIPTION OF THE RELATED ART

The main characteristics of networks such as the 802.11 wireless networks are the use of electromagnetic waves to transport the data, the capability of connecting mobile devices, the compatibility with the Ethernet framework, all of which allow for easy development of classical local network infrastructure in all those locations where it is difficult or not convenient to deploy wires.

Essentially, these networks can operate in two basic modes.

A first mode of operation is currently referred to as the infrastructure mode. In this mode, a specific device, called the access point (AP), manages all the communications in the network. The access point is responsible for roaming and maximizing the coverage. This mode of operation is used in large infrastructures where several terminals and communication systems could be outside the direct range of each other. An infrastructure mode of operation is illustrated in FIG. 1, where AP designates the access point, and T are various terminals distributed over the network coverage area NCA.

In another typical mode of operation, referred to as the ad-hoc mode, all the devices in the network may share directly the radio medium, without the intervention of a third party acting as the access point. Due to its very nature, this mode of operation is fully distributed and does not need any centralized mechanism, like the access point. This can be extremely useful in the domestic environment, where only moderate coverage is needed and cost is the most important issue. This mode of operation is illustrated in FIG. 2 where, again, T designates various terminals distributed over the network coverage area NCA.

Since radio waves are used to transport data, networks such as 802.11 networks make it relatively easy to eavesdrop on the network communications or masquerade as a legitimate user. The 802.11 standard therefore includes a mechanism for providing a security level equivalent to that available in a wired network. Such mechanism, known as the WEP (Wired Equivalent Privacy), operates by encrypting all the transmitted frames with a stream cipher, RC-4 (described e.g. in R. Rivest, “The RC4 Encryption Algorithm”, by RSA Data Security, Inc. Mar. 12, 1992). RC-4 takes, as input, a secret key of 40 bits (or 128 bits, in the stronger edition) and a public initialisation vector (IV) of 24 bits and generates a pseudo-random sequence that is XORed with the original frame; this enciphered frame is the one to be transmitted.

However, WEP has several well-known problems, addressed e.g. in the paper by Borisov et al. “Intercepting Mobile Communications: The Insecurities of 802.11”, Proceedings of MOBICOM 2001.

Essentially, the basic problems are mostly related to attacks that lead to accessing the original (non encrypted) data or the secret key, which allow a third party to fully compromise the network security.

The reuse of the initialisation vector (IV) is a main source of criticality. Using 24 bits, 2²⁴ different values are possible. A medium-loaded network can easily generate 1000 packet/sec, which causes a collision (that is, a reuse of the same IV for two different packets) approximately after 4 sec, according to Birthday Paradox theory. Two colliding packets give the opportunity to analyse an XOR combination of these, and decipher each packet using symbol frequency analysis. Of course, as more and more packets are collected, deciphering the data becomes even easier.

Moreover, the integrity of a single packet is protected using a simple CRC code; this kind of code is really useful only as a measure to detect transmission problems. If a skilled attacker can manipulate the frame, some key information can be easily modified altering the CRC code so that the packet is still valid. If the packet has a wrong checksum, the receiving terminal will usually drop it silently; so, it is possible to try several different combinations until a correct packet is successfully sent.

While all these attacks may be difficult to deploy in real-life scenarios, it has been recently demonstrated in the paper by Flurher et al. “Weakness in the Key Scheduling Algorithm of RC-4”, 8^{th} Annual Workshop On Selected Areas in Cryptography, August 2001, that another attack is extremely efficient in recovering the secret key. In fact, some specific choices for the initialisation vector (IV) may lead to special “weak” keys. These keys have the undesirable property that the initial output of the pseudo-random sequence, which constitutes the RC-4 stream code, is affected only by a small number of key bits. This weakness relates to a lack of diffusion in the sequence, and can be used to recover the key after enough packets associated with those keys are collected. A specific tool, which can be used for WEP key recovery, has been made publicly available and can be downloaded freely from the Internet. Because of this attack, the security of WEP is definitely broken.

The deficiencies of the WEP algorithms are well known in the security and networking community. Several independent vendors have developed different solutions addressing this problem.

For instance, the Temporal Key Integrity Protocol (TKIP), also referred as WEP-2, is an interim solution developed by the 802.11i group of the IEEE and is fully described in the IEEE Std. 802.11i/D3. Draft Supplement to Standard For Telecommunications and Information Exchange between Systems—LAN/MAN Specific Requirements; Part 11, Wireless Medium Access Control (MAC) and Physical Layer (PHY) Specifications: Specification for Robust Security.

This solution addresses the problem of initialisation vector reuse, but still relies on a static 128 bit shared master key that is distributed among the network clients. TKIP is based on a two-level approach: it combines the shared master key with the MAC address of the network adapter and a 128 bit random value to create a unique key used to generate the RC-4 keystream. Moreover, this derived key is changed every 10,000 packets.

More specifically, a shared master key is loaded in the device and it is used to generate a temporary WEP key, which is effectively used for the encryption process.

This approach is essentially based on the modification of the WEP key with a sufficient frequency so that it become infeasible to use the attack strategies described in the foregoing.

The main advantage of the TKIP mechanism is its compatibility with the previous WEP standard. Usually, only a firmware update is needed to integrate this feature.

However, this algorithm has several shortcomings; first of all, it is not believed to be very secure; moreover, it needs a single key for each entity connected to the network, plus a special key for broadcast packets. Finally, there is still the need to distribute a first key to initialise the process.

In brief, the TKIP mechanism does not solve the problem of distributing the single master key: a central authority associated to the network (e.g. via the access point) is needed for this purpose, and a secure communication has to be established with this central authority. If the central authority fails for some reason, it becomes impossible for a new party to join the network. Moreover, the central authority becomes the preferred attack point, if someone wants to violate the security of the network. When the server is compromised, or the master key is compromised, all the terminals have to be re-initialised, which requires distributing a new single central key among all the participants.

Additionally, the TKIP approach requires the use of a central authority: it is thus better used in the context of an infrastructure mode network, while it becomes more critical to be used in the ad-hoc mode because it is necessary to distribute the shared master key manually (e.g. by typing a code related to that key).

U.S. Patent Application US2003-0031151-A1 describes the use of the Mobile IP and IPSec Standard to address some of the WEP insecurities, especially during the roaming process. This is done by relying on an existing GPRS/UMTS infrastructure to perform authentication and key generation.

This approach appears cumbersome and unduly complex to deploy when considered in the scenario of a WLAN such as e.g. a small network serving an enterprise or a home.

### OBJECT AND SUMMARY OF THE INVENTION

The need therefore exists for an arrangement that solves the security problems of WEP by using a protocol that allows changing easily and automatically (without having to rely on a central authority, as is the case of TKIP) the secret key used to perform the WEP encryption.

Moreover, the need exists for arrangements that can be equivalently used both in the context of infrastructure networks and ad-hoc networks, by dispensing with the requirement for any central authority or key distribution entity.

All this while retaining the possibility of changing the key with sufficient frequency, in order to make extremely difficult to use the common attack techniques experimented against the WEP.

The object of the invention is to provide a response to such needs.

According to the present invention, such an object is achieved by means having the features set forth in the claims that follow.

The invention also relates to a corresponding network and computer program product directly loadable in the memory of at least one computer and including software code portions for performing the method of the invention when the product is computer run.

A significant feature of the invention is the use of protocols of the group key agreement type, preferably of the asymmetric kind. For a general review of group key agreement protocols (GKAPs), sometimes referred to also as key-exchange algorithms, reference can be made to the Handbook Of Applied Cryptography by Alfred J. Menezes et al., CRC Press, 1996 and especially Chapter 12 thereof.

These protocols may be resorted to when a group of two or more different terminals want to create a secret key. By “secret key” a key is meant that is known to the communicating terminals only. If the key is exchanged using a communication channel, it is possible for a third party to intercept this information or to subvert the entire communication process.

A protocol of the group key agreement type works in a network by exchanging in the network only publicly accessible information in such a way that this information cannot be used by a third party intercepting it to re-construct the key.

Only the parties that effectively exchange this information can derive the secret key. The public information is mathematically bound to a secret local data (created independently by the two communicating parties), which is never sent on the channel, but instead is stored securely on the terminal. It is computationally infeasible to reconstruct the secret local data only by observing the public information exchange.

By using the publicly exchanged information and the secret data, each party is able to independently construct the same key. Another party, who did not contribute any element in the protocol, will be unable to derive this secret key.

These protocols are the natural extension to groups of N>2 elements of the Diffie-Hellman protocol as described in W. Diffie, M. E. Hellman: “New Directions in Cryptography”; IEEE Transactions on Information Theory, Vol. IT-22, No.6, pp.644-654, 1976.

Group Key Agreement Protocols (GKAPs) have been used in the context of Secure Multicast IP Networks. The invention defines a mechanism, based on GKAPs, which can be used effectively with wireless local area network (WLANs), maintaining full compatibility with the existing WEP standard. The arrangement disclosed herein implements an effective way of exchanging all the information required to create a dynamic key without the need to share any a-priori secret master key. If a single terminal is compromised, it is sufficient to run the protocol again, and a complete new key, independent and unrelated to the previous one can be created.

Preferably, each single client of the network uses a digital signature scheme (e.g.: a digital certificate, with the relative certification chain) to authenticate the packets involved in the key agreement protocol. All these packets can be exchanged without any encryption, because they only contain public data.

Packets have to be digitally signed in order to prevent a non-trusted party from participating in the key agreement protocol.

If one of the participants receives a packet with an invalid signature, the packet is discarded and the sender is not allowed to participate in the key generation process.

When the procedure has been completed, all the parties can set their WEP key they have generated (independently of one another), and use WEP for further communication. When a new party joins or leaves the network, the key is generated again.

Also, when a certain amount of time is elapsed or a certain number of packets have been sent on the network, a key recalculation process is triggered again. This process greatly reduces the opportunity of exploiting the weaknesses in the WEP algorithm and gives acceptable security level for typical use.

### BRIEF DESCRIPTION OF THE ANNEXED DRAWINGS

The invention will now be described, by way of example only, with reference to the annexed figures of drawing, wherein:

FIGS. 1 and 2 have been described in the foregoing,

FIG. 3 shows a typical packet structure adapted to be used in the network described in the following, and

FIG. 4 details a typical finite state machine (FSM) embodiment of the arrangement described in the following.

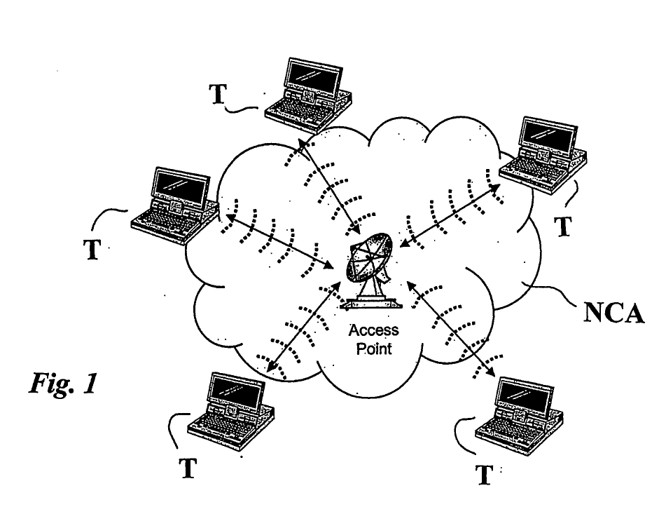

### DETAILED DESCRIPTION OF A PREFERRED EMBODIMENTS OF THE INVENTION

The exemplary embodiment described in the following is essentially based on the TGDH algorithm which is thoroughly described in the paper by Y. Kim, A. Perrig and G. Tsudik: “Simple and Fault-Tolerant Group Key Agreement”, ACM-CCS 2000, November 2000.

However, it can be easily extended and adapted to any Diffie-Hellman Group algorithm (e.g. the Hugues or the ElGamal algorithms, just to mention two examples) or other protocols of the distributed key agreement type.

The TGDH algorithm is based on the discrete logarithm problem. The key is computed executing a set of exponentiations, according to a binary tree ordering. The whole details of the TGDH algorithm are reported in the paper by Kim et al. referred to in the foregoing, thus making it unnecessary to provide a more detailed description herein. It will suffice here to recall that this algorithm (as several other GKAP algorithm) may need some intermediate steps to compute the key.

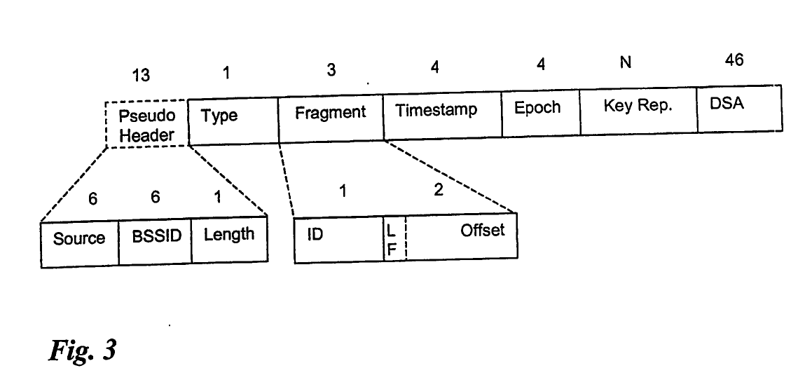

The structure of the protocol packet shown in FIG. 3 has been designed so to fit the characteristics of the 802.11b Authentication Frames.

The preferred length for each field (in bytes) is indicated above each field.

Basically, the packet can be carried inside one or more of this authentication frames, so that the protocol is fully compatible with the 802.11 specification. The maximum size for the payload of an authentication frame is 253 bytes and this is a constraint in the protocol definition.

Of course, the protocol packets can be also carried in other frames, but the authentication frames are the most indicated for this kind of transaction.

Moreover, other kind of 802.11b frame have also limitation on the maximum size of the payload, so the issue of maximum size is independent of the specific frame type chosen for transporting the protocol.

The length of each field is expressed in byte.

The Type field is used to distinguish between Join, Leave and Key message as better explained in the following.

The Fragment field usually includes three bytes used to implement a fragmentation mechanism: an ID field (1 byte) is used to distinguish between independent packets, an LF bit is used to indicate the Last Fragment, and an Offset (15 bits) into the packet.

This fragmentation mechanism mimics the one implemented in the IP protocol. The use of a fragmentation mechanism is largely preferred because the frame size of WLANS is limited, and the Key Representation field, which is a representation of the information required to build the complete key, may be fairly large. In fact the size of this field (N bytes) depends on the number of terminals T composing the group.

The Timestamp field conveys a 32 bit network integer (according the semantic conventionally used on IP networks) representing “the seconds since the Epoch”, where “Epoch” is defined according to Annex B 2.2.2. of the POSIX.1 Standard (IEEE Std 1003.1-2001).

The Epoch field is used to keep track of the current key agreement process. The epoch parameter is incremented each time the network generates a new shared-key. This permits easy tracking of desynchronised nodes, which have failed to acknowledge the beginning of a new key agreement.

As indicated, the Key Rep field conveys an encoded representation of the key tree, as described in the work by Kim et al. already repeatedly referred to in the foregoing.

Essentially, this can be derived from the tree structure by labelling each node with the following recurrence:

| | |
|---|---|
| Label(Left_Son) = | 1 |
| Label(Left_Son) = | 2 * Label(Father) |
| Label(Right_Son) = | 2 * Label(Father) + 1 |

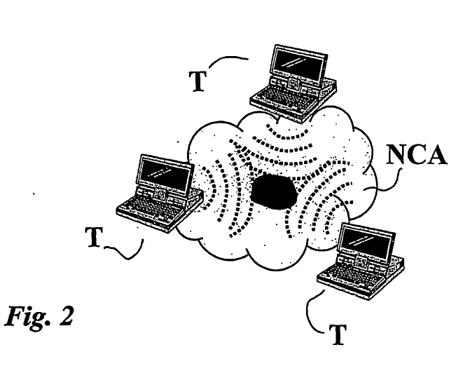

Each node (i.e. each terminal T in a network as shown in FIG. 2) essentially contains a binary number and is encoded by prefixing it with its label. The set of nodes is then encoded in a vector of these augmented nodes and constitutes the key representation. All this information is required to build the shared secret, whereby the key finally used for communication over the network is generated from coded information representative of each terminal T.

The last field is a DSA (digital signature algorithm) signature (46 bytes) of the entire packet.

A pseudo-header is also provided that contains the source address, the Network Name (the so called BSSID) and the length of the challenge payload.

All these fields come from the lower data-link layer (the 802.11b Authentication Frame) and are included in the signature in order to avoid “spoofed” packets.

The packet structure just described may be further optimised in terms of space allocation. In fact, the payload (for an authentication frame) is 253 bytes. The basic protocol fields account for 58 bytes (46 are for the DSA signature); the available payload for key representation is in the range of 1-195 bytes. The Key Representation is roughly 512×N bytes, where N is the number of the current element of the wireless group; so several packets are required to transport the key.

An alternative implementation, providing for more efficient space allocation, can be based on the use of two different sub-protocol layers: the lower layer provides only basic fragmentation of packets; the upper layer transports the effective Group Key Agreement Protocol Packet.

The DSA signature is applied over the entire GKAP packet plus the pseudo-header (which is the same for all the fragments, as the length field can be incorporated in the fragment handling protocol); in this way, the space and computational overhead due to insertion of the DSA signature in any packet sent at the data-link layer is avoided.

The protocol(s) just described use three different kinds of messages; they are all transmitted as broadcast messages.

A first message is the JOIN message. This message is generated whenever a new member wants to enter the group; this message already contains a Key Representation, which is basically composed by the information generated by the joining node. This data, merged with the other information provided by all the other nodes of the group, can be used to generate the new group key.

Another type of message is the KEY message: this message is generated during the key computation stage, and essentially contains the data that the other nodes of the network have to provide for computing the shared key.

A third type of message is the LEAVE message: this message has a null tree representation and is used to notify the other members that the source node is leaving the group.

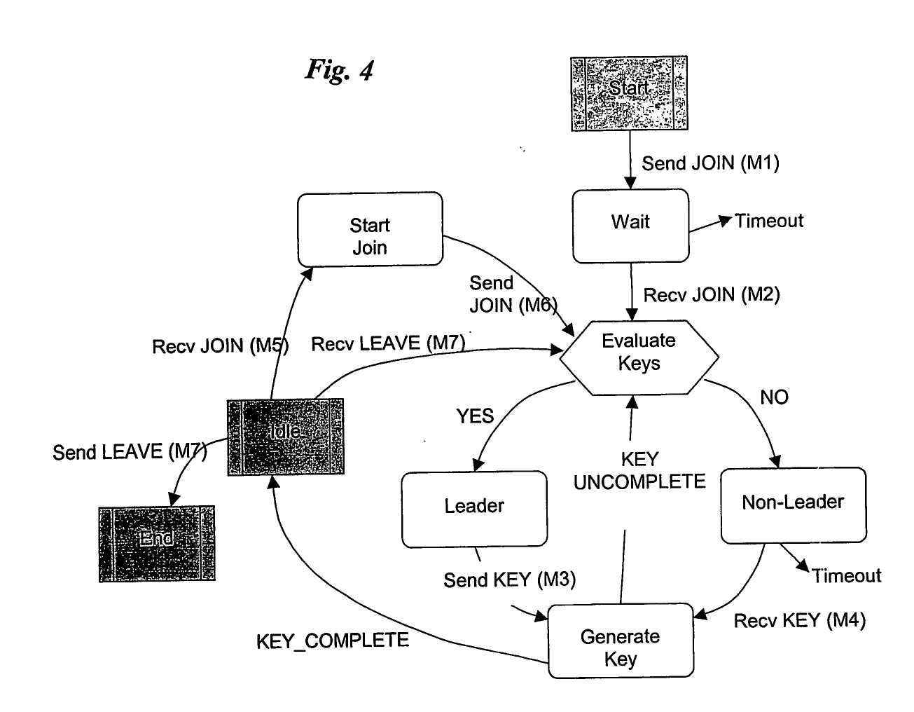

A reduced state machine corresponding to the protocol just described is depicted in FIG. 4.

This is a simplified graph which does not contain the extra states required to handle timeouts; timeout management will however be discussed in the following description.

The protocol works as follows.

When a new terminal, such as a terminal labeled X enters the Wireless LAN the terminal will be in the state [START]; it sends a first message (state M₁) to require a JOIN operation; all the other members of the group, which are in the state [IDLE] receive this message (state M₅).

All the terminals that compose the wireless group will then enter the [EVALUATE KEYS] state. The new X member also receives the message and acknowledges this event by moving to the [EVALUATE KEYS] state.

The group key agreement algorithm is run and a possible leader is elected. The leader election is merely an artificial way to select a node that can broadcast to the other nodes the other information required to build the secret key. The leader sends this data (message M₃), and all the members of the wireless group receive the required information (message M₄).

The [GENERATE KEY] step is run; if enough information has been collected, all the nodes have the key and can begin the communication e.g. according to the WEP mechanism.

Otherwise, if other information is needed, an [EVALUATE KEYS] state is run again.

When a terminal T wants to leave the network (this can happen only when the terminal has settled, and it is in the [IDLE] state), it sends a LEAVE message (M₇). This is processed by all the other members of the group (it is received again as the message M₇). The [EVALUATE KEYS] and the [GENERATE KEY] steps are run again, and the whole system generates a new key.

Significantly, this key cannot be derived by the node that left, because he did not provide any data for the key agreement process.

Basically, it will be assumed that the data-link layer can only transmit a frame at any given time. So it is substantially impossible that two frames can be received simultaneously.

Of course, the data-link layer is not based on physical connection and, as such, does not provide any guarantee that the messages are effectively delivered.

Message loss is thus a possible event to be coped with. This is done by using timeouts.

Timeouts are required on non-idle states each time a message is waited to continue. If a timeout elapses, the protocol performs a LEAVE first, and then tries to JOIN the group again. If this fails for a given number of times, the protocol will return an error condition to the upper layer.

Although the exemplary implementation disclosed herein substantially based on the TGDH protocol, it is easy to extend the implementation to include other forms of protocols of the group key agreement type.

As indicated, it is also possible to use a two-layer approach instead of the single layer approach primarily considered in the foregoing, so as to split the fragmentation mechanism and the effective GKAP.

The previous detailed description of those embodiments that are presently preferred refers to the use of management frames as defined in the 802.11 standard. Those of skill in the art will promptly appreciate that other types of management frames, and also data frames, can be used to carry a protocol of the type disclosed herein.

Of course, without prejudice to the underlying principles of the invention, the embodiments and details may vary, also significantly, with respect to what has been previously described and shown, by way of example only, without departing from the scope of the invention, as defined by the claims that follow.

1-32. (canceled)

33. A process for secure communication over a wireless network including a group of terminals, wherein such terminals exchange information ciphered by means of at least one key, comprising the step of generating said at least one key independently at each said terminal in said group by means of a protocol of the group key agreement type.

34. The process of claim 33, comprising the steps of:
generating, at each said terminal in said group, respective secret local data and maintaining said local data secret at said terminal;
exchanging publicly accessible information among the terminals in said group; and
generating, independently at each said terminal in the group, said at least one key on the basis of said respective local data maintained secret at each said terminal and said publicly accessible information.

35. The process of claim 34, comprising the step of incorporating to said publicly accessible information coded information representative of each terminal in said group, whereby generation of said at least one key is contributed by all the terminals in said group.

36. The process of claim 35, comprising the steps of:
encoding each terminal in said group by means of respective labels; and
generating a vector of the labels of all the terminals in said group, wherein said vector is included in said publicly accessible information exchanged among the terminals in said group.

37. The process of claim 34, wherein publicly accessible information exchanged among terminals in said group is representative of a tree-structure for generating said at least one key.

38. The process of claim 33, comprising the step of generating said at least one key independently at each said terminal in said group by means of a Diffie-Hellman group algorithm.

39. The process of claim 38, wherein said algorithm is the TGDH algorithm.

40. The process of claim 33, comprising the step of each terminal in said group authenticating itself by means of digital authentication information.

41. The process of claim 40, comprising the step of each terminal in said group authenticating itself by means of a digital certificate.

42. The process of claim 34, comprising the step of exchanging said publicly accessible information by means of information packets.

43. The process of claim 42, comprising the step of fragmenting said publicly accessible information over a plurality of information packets.

44. The process of claim 34, comprising the steps of each terminal in said group authenticating themselves by means of digital authentication information, fragmenting said publicly accessible information over a plurality of information packets and associating said authentication information with all of said packets.

45. The process of claim 34, comprising the steps of each terminal in said group authenticating themselves by means of digital authentication information, fragmenting said publicly accessible information over a plurality of information packets and including said digital authentication information with one of said packets, whereby the remaining part of said plurality of packets comprises a lower protocol layer conveying information resulting from said fragmentation.

46. The process of claim 33, comprising the step of configuring said each terminal in said group for generating at least one message selected from the group of:
a join message generated when said terminal enters said group and conveying information that merged with other information provided by all the other terminals in said group is adapted to generate said at least one key;
a key message generated during the generation of said at least one key and containing data that respective terminals other than a new terminal joining said group have to provide for generating said at least one key; and
a leave message generated to notify the other terminals in said group that the source terminal is leaving the group.

47. The process of claim 33, wherein when a new terminal joins said group, it includes the step of selecting one of the other terminals in the group for exchanging said publicly accessible information with said new terminal joining the group.

48. A wireless network for secure communication among a group of terminals, wherein such terminals exchange information ciphered by means of at least one key, comprising terminals in said group configured for generating said at least one key independently at each terminal by means of a protocol of the group key agreement type.

49. The network of claim 48, wherein the terminals in said group are configured for:
generating, at each said terminal in said group, respective secret local data and maintaining said local data secret at said terminal;
exchanging publicly accessible information among the terminals in said group; and
generating, independently at each said terminal in the group, said at least one key on the basis of said respective local data maintained secret at each said terminal and said publicly accessible information.

50. The network of claim 49, wherein the terminals in said group are configured for incorporating to said publicly accessible information coded information representative of each terminal in said group, whereby generation of said at least one key is contributed by all the terminals in said group.

51. The network of claim 49, wherein the terminals in said group are configured for:
encoding each terminal in said group by means of respective labels; and
generating a vector of the labels of all the terminals in said group, wherein said vector is included in said publicly accessible information exchanged among the terminals in said group.

52. The network of claim 49, wherein the terminals in said group are configured for exchanging among them publicly accessible information representative of a tree-structure for generating said at least one key.

53. The network of claim 48, wherein the terminals in said group are configured for generating said at least one key independently at each said terminal in said group by means of a Diffie-Hellman group algorithm.

54. The network of claim 53, wherein said algorithm is the TGDH algorithm.

55. The network of claim 48, wherein the terminals in said group are configured for authenticating themselves by means of digital authentication information.

56. The network of claim 55, wherein the terminals in said group are configured for authenticating themselves by means of a digital certificate.

57. The network of claim 49, wherein the terminals in said group are configured for exchanging said publicly accessible information by means of information packets.

58. The network of claim 49, wherein the terminals in said group are configured for fragmenting said publicly accessible information over a plurality of information packets.

59. The network of claim 49, wherein the terminals in said group are configured for authenticating themselves by means of digital authentication information, fragmenting said publicly accessible information over a plurality of information packets and associating said authentication information with all of said packets.

60. The network of claim 49, wherein the terminals in said group are configured for authenticating themselves by means of digital authentication information, fragmenting said publicly accessible information over a plurality of information packets and including said digital authentication information with one of said packets, whereby the remaining part of said plurality of packets comprises a lower protocol layer conveying information resulting from said fragmentation.

61. The network of claim 48, wherein the terminals in said group are configured for generating at least one message selected from the group consisting of:
a join message generated when said terminal enters said group and conveying information that merged with other information provided by all the other terminals in said group is adapted to generate said at least one key;
a key message generated during the generation of said at least one key and containing data that respective terminals other than a new terminal joining said group have to provide for generating said at least one key; and
a leave message generated to notify the other terminals in said group that the source terminal is leaving the group.

62. The network of claim 48, wherein the terminals in said group are configured for selecting, when a new terminal joins said group, one of the other terminals in the group for exchanging said publicly accessible information with said new terminal joining the group.

63. The network of claim 48, comprising a network according to the 802.11 standard.

64. A computer program product, directly loadable in the memory of at least one computer and including software code portions adapted for implementing the method of any one of claims 33-47.
